(19) United States
(12) Patent Application Publication
(10) Pub. No.: US 2011/0148541 A1
(43) Pub. Date: Jun. 23, 2011

(54) TRANSMISSION MEDIUM

(76) Inventor: Toru Sugama, Tokyo (JP)

(21) Appl. No.: 12/602,748

(22) PCT Filed: Sep. 11, 2008
(86) PCT No.: PCT/JP2008/066426

§ 371 Date: Dec. 2, 2009

(51) Int. Cl. H04B 3/28; H01P 3/00

(52) U.S. Cl. 333/12; 333/236

(57) ABSTRACT

A transmission medium includes: first and second lines #1 and #2, which are separated from each other and arranged substantially in parallel with each other; a third line #3, which is alternately entangled and wound around the first and second lines from one direction thereof so as to form a plurality of entangling portions Po to Pn in a longitudinal direction of the first and second lines, respectively; and a fourth line #4, which forms a plurality of entangling portions Po to Pn where the fourth line is alternately entangled and wound around the first and second lines from one direction thereof and a plurality of intersecting portions C1 to Cn where the fourth line intersects the third line internally of the first and second lines in the longitudinal direction of the first and second lines, respectively, wherein, the respective entangling portions of the third and fourth lines are alternately disposed in the longitudinal direction of the first and second lines, respectively, the winding direction of one of the first and second lines is the same as the winding directions of the respective entangling portions of the third and fourth lines, the winding directions of the respective entangling portions of the first and second lines are alternately opposite directions each other, and the overlapping directions of the third and fourth lines in the respective intersecting portions are alternately opposite directions each other in the longitudinal direction of the first and second lines.

### TECHNICAL FIELD

The present invention relates to a transmission medium, and more particularly, to a transmission medium in which phase delay and amplitude attenuation (voltage drop) of a signal and an electric power are very small when the signal and the electric power are transmitted.

### BACKGROUND ART

In general, when a signal and an electric power are transmitted through a transmission path, it is unavoidable that transmission characteristics are deteriorated in that the voltage of the signal received on a signal receiving side and the voltage of the electric power received on an electric power receiving side are dropped (amplitudes are attenuated) with respect to a transmitted signal (input) or the phase of them are delayed due to a resistance component and an inductance component of the transmission path. It is an essentially important matter to design the arrangement of the transmission path so as to minimize the phase delay and the voltage drop and to optimize the transmission characteristics.

In particular, when a high-frequency signal is transmitted, the signal is deteriorated considerably by being greatly affected by a floating capacitance and inductance existing in the transmission path, a loss due to a skin effect, a dielectric loss, and the like, a frequency dispersion and the like so that when a signal is transmitted in a long distance, it is necessary to locate a relay for amplifing the high-frequency signal on the way of the transmission.

In order to improve the inconvenience due to the signal deterioration mentioned above, in a conventional technology, in previous consideration of the deterioration of the waveform due the loss, it has been made practical to provide an equalizer for making the transmission side signal waveform to a waveform in which the deteriorated waveform is compensated. However, this involves a problem in that provision of the equalizer increases a cost and makes the arrangement complex. Further, it is also proposed to cope with the above problem by separating a high-frequency component having high signal deterioration from a low-frequency component having low signal detrioration. For example, a transmitted signal is separated to a low-frequency component and a high-frequency component by a waveform deterioration compensation unit having a plane pattern formed in a flat C-shape.

More specifically, a high-frequency transmission path, which makes use of an inter-wiring capacitance, is formed using the fact that the impedance of the high-frequency component is small with respect to a capacitance, and the high-frequency component is separated by the high-frequency transmission path. In contrast, the low-frequency component is separated using a low-frequency transmission path which is composed of a C-shaped conductor path longer than the high-frequency transmission path by a predetermined amount and caused to pass therethrough. According to such arrangement, a transmission time difference is set between the low-frequency transmission path and the high-frequency transmission path, and the high-frequency component is transmitted faster than the low-frequency component to thereby compensate for the waveform deterioration (the delay of the high-frequency component whose transmission speed is slower than that of the low-frequency component is compensated for by the difference of distances). Deterioration of a signal waveform is hence compensated for by synthesizing a result of the operation. The waveform deterioration compensated transmission path arranged as described above is disclosed in Patent Document 1 (Japanese Unexamined Patent Application Publication No. 2004−297538).

Such signal deterioration likely occurs in wirings of an integrated circuit. For example, an integrated circuit, which operates at a clock frequency equal to or larger than gigahertz, is greatly affected by the ground as a return current path in addition to the inductance component of the wirings. That is, since a floating capacitance and inductance, which are not disadvantageous in a low-frequency region, causes a serious problem in a high frequency region, a return current strongly depends on the frequency characteristics of the wirings and does not necessarily pass through the ground. As a result, when a high frequency signal is transmitted through a transmission path, the transmission characteristics are deteriorated, and a voltage level drops and a phase delays further in an output end.

As described above, the quality of a signal transmitted in the signal transmission path is affected by the resistance component, the capacitance component, and the inductance component of the transmission path itself. In particular, in a high-frequency transmission, since the floating components of these components greatly affect a signal, a signal amplitude is greatly attenuated (voltage is dropped) as well as a phase is greatly delayed, and thus, an eye pattern which is a parameter for evaluating transmission characteristics is greatly collapsed, which is the most significant problem of the signal transmission.

Conventionally, for example, when respective different signals, which originally have no phase offset, are transmitted through two transmission paths by different transmission characteristics, a phase difference occurs between both the signals due to the difference of the transmission frequency characteristics of the transmission paths. In order to compensate for this phase difference, the phase difference between both the signals is compensated for by delaying a faster signal (signal having a smaller phase delay) by a delay unit. However, this method is contrary to a requirement for absolutely increasing a signal transmission speed because the phase of a signal having small delay time is intentionally caused to agree with the phase of a signal having a large delay time.

Further, the conventional technology provides no countermeasure for deterioration of an amplitude (voltage drop) mainly caused by the resistance component of the transmission path except a countermeasure of amplifying the amplitude by an amplifier incorporated in a relay on the way of the transmission. In the amplification, however, there is a possibility of also amplifying noise, which may cause a possibility of lowering an S/N ratio.

In short, since the conventional technology employs only a negative countermeasure of carrying out compensation by intentionally deteriorating good characteristics so that the good characteristics are caused to accord with bad characteristics, it is impossible to fundamentally eliminate deterioration of a signal during the transmission through the transmission path.

### DISCLOSURE OF THE INVENTION

Accordingly, the inventor of the subject application proposed a transmission medium in which a phase is much less delayed in transmission of a signal, an amplitude is also much less attenuated (voltage is much less dropped), and signal deterioration is very small as compared with a conventional art (Japanese Patent Application No. 2006−67039 (filed on Mar. 15, 2007), which is called a previous application of the same applicant).

As shown in FIG. 11, in the previous application, which has not be publicly known, first and second linear conductor wires #1, #2 each composed of a conductive material are disposed approximately in parallel with each other in a separated state, and a third curved conductor wire #3 composed of a conductive material is wound around the first and second conductor wires #1, #2 along the longitudinal direction thereof by being alternatively entangled therewith from one direction, respectively. Further, a fourth curved conductor wire #4 composed of a conductive material is wound around the first and second conductor wires #1, #2 by being alternatively entangled therewith from one direction along the wires in a shape opposite to that of the third conductor wire #3.

More specifically, in the method of knitting the transmission medium, when it is observed how the three conductor wires #1, #3, #4 overlap in an upper triangle “ta” in FIG. 11 surrounded by points I, II, III, the fourth conductor wire #4 passes above (on) the first conductor wire #1 at the point I and below (under) the third conductor wire #3 at the intersecting point II. When this state is shown as #4: I (above the conductor wire 1)→II (below the conductor wire 3), the third conductor wire #3 overlaps in such a manner of the conductor wire #3: II (above the conductor wire 4) III (below the conductor wire 1), and the first conductor wire #1 overlaps in such a manner of the conductor wire #1: III (above the conductor wire 3)→I (below conductor wire 4) so that the three conductor wires #1, #3 and #4 are symmetrical by intersecting alternately.

However, the three conductor wires #1, #3 and #2 overlap in a lower triangle “tb” in FIG. 11 surrounded by points IV, II, V in such a manner of the conductor wire #3: IV (above the conductor wire 2)→II (above conductor wire 4), the conductor wire #4: II (below the conductor wire 3)→V (below conductor wire 2), and the conductor wire #2: V (above the conductor wire 4) →IV (below the conductor wire 3) so that the conductor wire #3 passes above (on) the other two conductor wires #1 and #2 at both the locations of the points II and V (that is, it can be also said that the conductor wire #4 passes below (under) the other two conductor wires #2 and #3 at both the locations of the points II and V).

However, in such the previous application, when an external force is applied to the transmission medium so as to pull it in, for example, a longitudinal direction, since the overall shape of the transmission medium is deformed and thus the triangles “ta” and “tb” in which an electromagnetic field is generated, are deformed, a sufficient space cannot be formed, thus providing an inconvenient matter.

More specifically, at the points I and III, the first conductor wire #1 is tightened so as to be sandwiched by the fourth conductor wire #4 or the third conductor wire #3, and further, a tightening force is strong because positionally upper/lower relationship between the fourth and third conductor wires #4 and #3 to the first conductor wire #1 is opposite to positionally upper/lower relationship between the fourth and third conductor wires #4 and #3 in the intersecting portion II. However, the relationship between the third and fourth conductor wires #3 and #4 to the second conductor wire #2 is the same as that in the intersecting point II at the points IV and V, and, hence, the force, by which the second conductor wire #2 is tightened by the third and fourth conductor wires #3 and #4, is weakened.

This behavior is shown in FIG. 12. When an upward force and a downward force, which the first conductor wire #1 receives from the fourth conductor wire #4 at the point I, are shown by fIVu and fIVd, respectively, and an upward force and a downward force, which the second conductor wire #2 receives from the third conductor wire #3 at the point IV, are shown by fIVu, fIVd, respectively, an equation of fIu=fId>fIVu=fIVd is established. Accordingly, when an external force is applied to the transmission medium, the transmission medium is loosened at the point at which the second conductor wire #2 is sandwiched, and therefore, the overall shape of the transmission medium is liable to be collapsed. In particular, since the spaces of the triangles “ta” and “tb”, in which the electromagnetic field is generated, cannot be sufficiently maintained, a phase is delayed and an amplitude attenuation effect is reduced when transmitting a signal, thus providing an inconvenient matter.

An object of the present invention, which was made in view of the new knowledge mentioned above, is to provide a transmission medium the overall shape of which is less deformed even if an external force is applied thereto and which can improve a phase delay and an amplitude attenuation effect.
The present invention provides a transmission medium comprising:

first and second conducting wires, which are separated from each other and disposed substantially in parallel with each other;

a third conducting wire, which is alternately entangled and wound around the first and second conducting wires from one direction thereof so as to form a plurality of entangling portions in a longitudinal direction of the first and second conducting wires, respectively; and

a fourth conducting wire, which forms a plurality of entangling portions where the fourth conducting wire is alternately entangled and wound around the first and second conducting wires from one direction thereof and a plurality of intersecting portions where the fourth conducting wire intersects the third conducting wire internally of the first and second conducting wires in the longitudinal direction of the first and second conducting wires, respectively,

wherein, the respective entangling portions of the third and fourth conductor wires are alternately arranged along the longitudinal direction of the first and second conductor wires, respectively, the winding direction of one of the first and second conductor wires is the same as the winding directions of the respective entangling portions of the third and fourth conductor wires, the winding directions of the respective entangling portions of the first and second conductor wires are alternately opposite directions each other, and the overlapping directions of the third and fourth conductor wires in the respective intersecting portions are alternately opposite directions each other in the longitudinal direction of the first and second conductor wires.

According to the present invention, when signal and electric power are transmitted, the phase delay and the amplitude attenuation (voltage drop) of the signal and the electric power can be greatly reduced. Further, even if external force such as tension and the like is applied to the transmission medium in a longitudinal direction, since the change of the overall shape thereof can be suppressed, the phase delay and the amplitude attenuation can be suppressed.

In a preferred embodiment of the present invention, the following subject features would be attained.

In the invention, the first to fourth conductor wires are preferably disposed in a range in which an electromagnetic interaction caused by a current flowing in the conductive wires acts.

In the invention, the third and fourth conductive wires have modes of shapes preferably formed in a sine wave shape by being entangled with the first and second conductor wires.

In the invention, the third and fourth conductive wires have modes of shapes preferably formed in a chevron shape by being entangled with the first and second conductor wires.

In the invention, the first to fourth conductor wires are preferably commonly connected on the input end sides and the output end sides thereof.

In the invention, the first and second conductor wires are preferably commonly connected on the input end sides and the output end sides thereof, and the third and fourth conductor wires are preferably commonly connected on the input end sides and the output end sides thereof.

In the invention, the commonly connected portions of the first and second conductor wires are preferably grounded, and electric power such as signal is preferably input from the commonly connected input side of the third and fourth conductor wires.

In the invention, the first and second conductor wires are preferably commonly connected on the input end sides and the output end sides thereof, and the third and fourth conductor wires are preferably used as independent conductor wires.

In the invention, the first and second conductor wires are preferably commonly connected and grounded, and the third and fourth conductor wires are preferably used as independent signal conductor wires.

### BRIEF DESCRIPTION OF THE DRAWINGS

FIG. 1A is a plan view of a portion of a transmission medium according to an embodiment of the present invention, and FIG. 1B is a principle view of FIG. 1A.

FIG. 2 is a schematic plan view of another embodiment of the present invention showing a simplified arrangement in which four lines are used as one line by coupling the input sides thereof with the output sides thereof.

FIG. 3 is a schematic plan view of a further embodiment of the present invention showing a simplified arrangement in which two linear lines, which are coupled with each other, and two curved lines, which are coupled with each other, are used as two lines.

FIG. 4 is a schematic plan view of a still further embodiment of the present invention showing a simplified arrangement in which four lines are independently used.

FIG. 5 is a schematic view showing an arrangement of a measuring instrument used in an experiment and a measurement for verifying an effect of the present invention.

FIG. 6A is a waveform view observed by an oscilloscope on an output side when a sine wave signal is input to a transmission medium according to the present invention, and FIG. 6B is a waveform view of a conventional transmission path.

FIG. 7A is a waveform view observed by the oscilloscope on the output side when a square wave signal is input to the transmission medium according to the invention, and FIG. 7B is a waveform view of the conventional transmission path.

FIG. 8A is a schematic view showing a distribution of an electromagnetic field of the transmission medium shown in FIG. 1A on a secondary plane, and FIG. 8B is a view of a mathematically theoretical model of FIG. 8A.

FIG. 9A is a schematic view showing a set example (0) of a theoretical equation of the mathematically theoretical model shown in FIG. 8B, and FIG. 9B is a schematic view showing a portion of a set example of a theoretical equation (2) of the mathematically theoretical model shown by FIG. 8A.

FIG. 10A is a partially enlarged plan view of a transmission medium showing stress and the like when an external force is applied to the transmission medium shown in FIG. 1A, and FIG. 10B is a partially enlarged perspective view of the transmission medium showing the stress shown in FIG. 10A.

FIG. 11 is a partially enlarged plan view of a transmission medium according to an application prior to the present invention.

FIG. 12 is a partially enlarged perspective view of the transmission medium shown in FIG. 11.

### BEST MODE FOR CARRYING OUT THE INVENTION

Embodiments of the present invention will be explained hereunder with reference to the accompanying drawings. It is to be noted that the same or corresponding portions in the accompanying drawings are denoted by the same reference numerals.

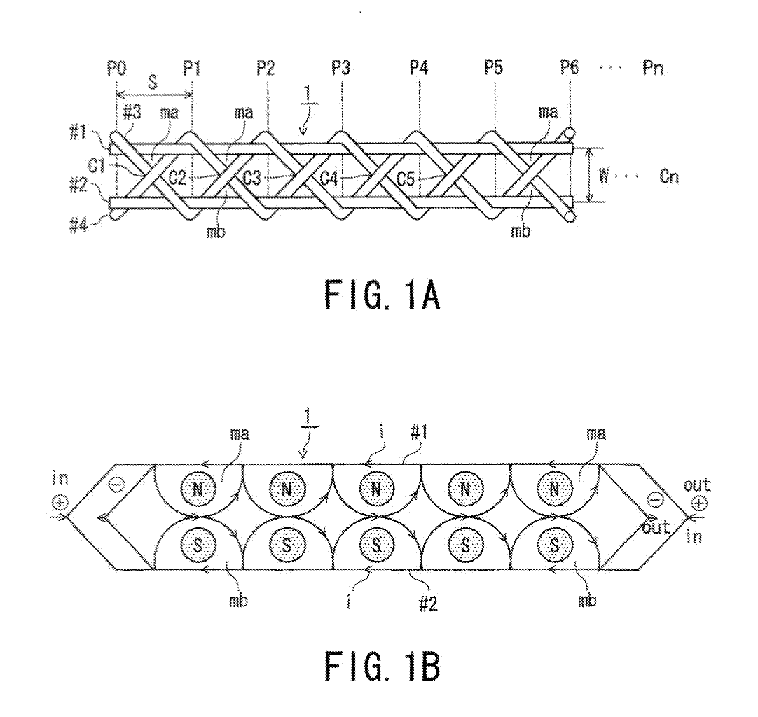

With reference to FIG. 1A, the transmission medium 1 has first and second lines #1 and #2 as first and second linear conductor wires, which are disposed approximately in parallel with each other at necessary spacings W, and third and fourth curved lines #3 and #4 as third and fourth conductor wires, which are repeatedly wound between the first and second lines #1 and #2 in a longitudinal direction of the first and second lines #1 and #2 in an approximate 8-shape at approximately a 180° different phase.

The conductive surfaces of the respective lines #1 to #4 are covered with an insulating film. However, these lines may be placed in a state in which the respective lines are not in contact with each other even if the lines are not covered with the insulating films.

The respective lines #1 to #4 may be composed of an ordinary conductive wire, and any type of conductive materials such as copper, aluminum and the like may be employed.

The spacing distance W between the first and second lines #1 and #2 is, for example, about 4 mm, and the spacings S of the positions at which the first and second lines #1 and #2 are entangled with the third and fourth curved line lines #3 and #4 are about 5 mm. However, these sizes may be appropriately selected according to a use of the transmission medium 1.

The transmission medium 1 has a large feature in an entangling portion, in which the third and fourth curved lines #3 and #4 are entangled with the first and second lines #1 and #2, and in a knit structure.

More specifically, as shown in FIGS. 1A and 1B, as to the chevron-shaped or sine wave-shaped third and fourth curved lines #3 and #4 at an entangling position P1 as an entangling portion, the third curved line #3 is entangled with the second line 2 located below it in the illustration of FIG. 1 in such a manner of being bent so as to run round it from a proximal (i.e., upper) side to a distal (i.e., lower) side in the illustration, and, at a next entangling position P2, the third curved line #3 is entangled with the first linear line #1 located thereon in the illustration so as to run round it from a lower side to an upper side.

Further, the third curved line #3 is entangled with the second linear line #2 so as to be bent from the upper side thereof to the lower side thereof at a next entangling position P3, is entangled with the first linear line #1 located at an upper position from the lower side thereof to the upper side thereof at an entangling position P4, and is entangled with the second linear line #2 from the upper side thereof to the lower side thereof at an entangling position P5, and thereafter, the third curved line #3 is entangled and knitted likewise.

Accordingly, the entangling positions (entangling portions) P1 to P5 of the curved line #3 are repeated in the longitudinal direction of the first and second lines #1 and #2.

In contrast, in FIGS. 1A and 1B, the fourth curved line #4 is entangled with the first linear line #1 located at the upper position in the illustration of FIG. 1 in such a manner of being bent so as to run round it from the lower side thereof to the upper side thereof at the entangling position P1 and is entangled with the linear line 2 so as to be bent from the upper side thereof to the lower side thereof at the entangling position P2. Further, the fourth curved line #4 is entangled with the linear line #1 so as to be bent from the lower side thereof to the upper side thereof at the next entangling position P3, is entangled with the linear line #2 so as to be bent from the upper side thereof to the lower side thereof at the entangling position P4, and is entangled with the linear line #1 so as to be bent from the lower side thereof to the upper side thereof at the entangling position P5, and thereafter, the fourth curved line 4 is entangled and knitted likewise.

Accordingly, the entangling positions (entangling portions) P1 to P5 of the curved line #4 are repeated in the longitudinal direction of the first and second lines #1 and #2.

At the respective entangling positions P1 to P5, the third and fourth curved lines #3 and #4 are entangled in such a manner that these lines are bent so as to run round first line #1 from the lower side to the upper side thereof on the first line #1 side. In contrast, on the second line #2 side, the third and fourth curved lines #3 and #4 are entangled with the second line #2 in such a manner that these lines are bent so as to run round from the upper side to the lower side thereof, and thus the run-round direction thereof is reversed, i.e., the winding direction thereof with respect to the first line #1 is reversed from that with respect to the second line #2.

More specifically, as shown in FIG. 1A, at the respective entangling portions P0 to Pn of the first line #1 located at the upper position in the illustration of FIG. 1, the curve-shaped third and fourth curved lines #3 and #4 run round the first line 11 from the lower (distal) side to the upper (proximal) side thereof and are wound by being bent at a required angle such as right angles and the like.

In contrast, in FIG. 1A, at the entangling portions P0 to Pn of the second line #2 located at a lower position, the curve-shaped third and fourth curved lines #3 and #4 run round the second line #2 from the upper (proximal) side to the lower (distal) side thereof in the illustration as well as wound at a required angle such as approximately right angles, and the winding direction thereof is opposite to that of the first line #1.

Accordingly, when a horizontal center line, not shown, which extends in parallel with the first and second lines #1 and #2, is used as a symmetric axis in the intermediate points in the separating direction of the first and second lines #1 and #2, the winding directions of the entangling portions P0 to Pn of the first and second lines #1 and #2 are made asymmetric.

In the respective intermediate portions in the longitudinal direction of the respective entangling portions P0 to Pn of the respective lines #1 to #4, intersecting portions C1, C2, . . . , Cn, at which the third line #3 intersects the fourth line #4 at a required angle such as right angles, are formed. At the intersecting portions C1, C2, . . . , Cn, one of the third and fourth lines #3 and #4 extends on the upper (proximal) side of the other line and the third and fourth lines #3 and #4 intersect with each other so that the overlapping direction thereof is sequentially reversed in the longitudinal direction of the first and second lines #1 and #2.

For example, at the left intersecting point C1 in FIG. 1A, the fourth line #4 extends on the upper side of the third line #3, and at the next intersecting point C2, the third line #3 extends on the upper side of the fourth line #4, and, at the subsequent intersecting points C3 to Cn, a line extending on the upper side of intersecting points is sequentially reversed to the fourth line #4, the third line #3, . . . .

As shown in FIG. 1B, when a current “i” is supplied from an input (in) side on the entangling portion P0 side to an output (out) side, vertical variable magnetic fields N, of the N-pole, for example, are formed to the respective approximately triangular spaces ma, ma, . . . , ma formed by being surrounded by the first line #1, and the third and fourth curved lines #3 and #4, respectively, in FIG. 1A.

Further, vertical variable magnetic fields S of the S-pole, for example, are formed, respectively, to the respective approximately triangular spaces mb, mb, . . . , mb formed by the second line #2, and the third and fourth curved lines #3 and #4. The N- and S-pole vertical variable magnetic fields sequentially move in the longitudinal direction of the first and second lines #1 and #2.

Accordingly, it can be understood that the transmission medium 1 achieves a so-called self-exciting electron accelerating operation for accelerating the electrons of the current flowing in the respective lines #1 to #4 by the vertical variable magnetic fields N, S. More specifically, it may be said that the transmission medium 1 is a self-exciting electron accelerator, and theoretical explanation of this point will be made hereinlater.

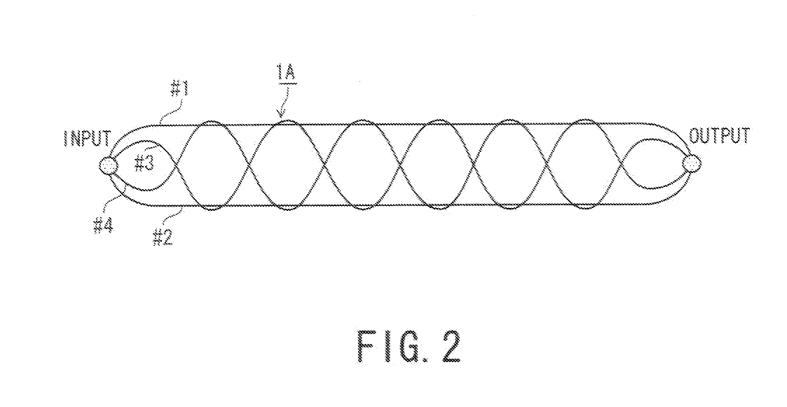

FIG. 2 is a schematic plan view of a transmission medium 1A according to a second embodiment of the present invention. In the transmission medium 1A in which the four lines #1 to #4 of the above-described transmission medium 1 are used as one line by coupling the input sides thereof with the output sides thereof.

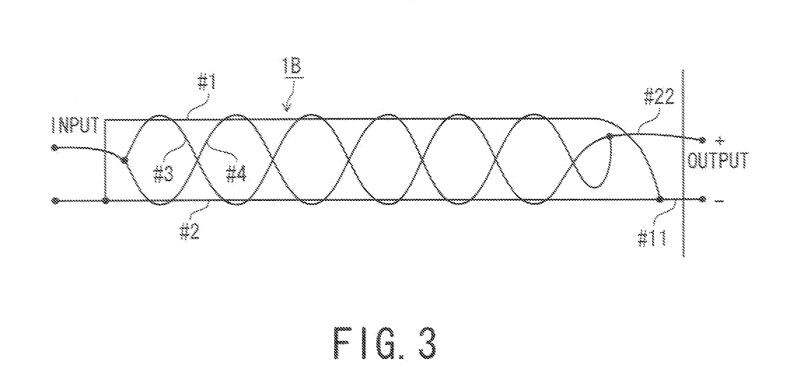

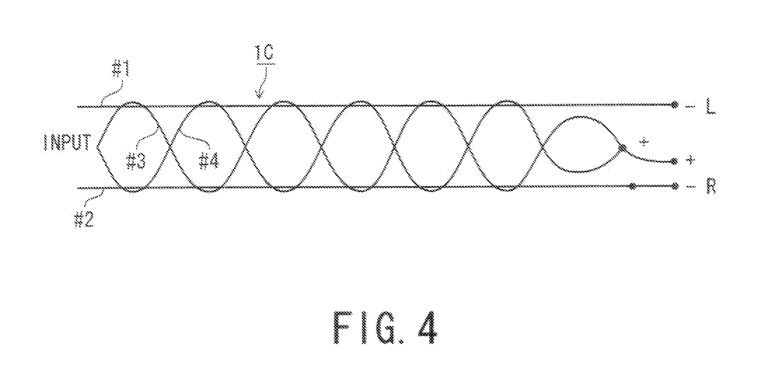

Further, the four lines #1 to #4 may be also used as two lines by coupling two linear lines #1 and #2 with each other and coupling two curved lines #3 and #4 with each other likewise a transmission medium 1B shown in FIG. 3. Further, each of four lines #1 to #4 can be independently used likewise a transmission medium 1C shown in FIG. 4. Further, two lines of the four lines #1 to #4 may be coupled with each other, and the remaining two lines may be used as independent lines. For example, the coupled two linear lines #1 and #2 are grounded and the remaining two lines are used as a # line and an R line of an audio stereo signal so as to remarkably improve the acoustic quality.

Further, in the transmission medium of FIG. 1A, the first and second linear lines #1 and #2 are knitted with the third and fourth curved lines #3 and #4 so as to be in contact with each other. Furthermore, the advantageous effect of the present invention can be achieved as long as the respective lines are disposed with each other in the arrangement mentioned above. For example, it is possible to dispose the first and second lines #1 and #2 in a state of being separated from each other by a predetermined distance (when an interaction of an electromagnetic field is generated) in a height direction and to dispose the two curved lines therebetween in a state of being separated from each other in a vertical direction. In this case, it is also necessary for all the lines #1 to #4 to be disposed in a range in which the lines are electromagnetically coupled with each other.

Hereunder, a result which was obtained by an experiment and a measurement at a time when a signal was transmitted using the transmission medium according to the invention of the arrangement or structure mentioned above will be described together with advantageous effects attainable thereby.

In the experiment, the attenuation (voltage drop) of the signal level of an input signal and the phase delay thereof on the output side of the input signal were measured by using the first and second linear lines line #1, #2 of FIG. 1 as a first line (forward path) by connecting and coupling the input sides and the output sides thereof and using the third and fourth curved lines #3 and #4 as a second line (return path) by connecting and coupling them.

In the experiment and the measurement executed based on the above arrangement, the input signal whose frequency was changed from 100 kHz to 20 MHz was transmitted through the transmission medium of the present invention, and the phase delay and the signal attenuation state of an output signal were measured by an oscilloscope on the output side. Further, a similar experiment was executed to a conventional transmission path for comparison.

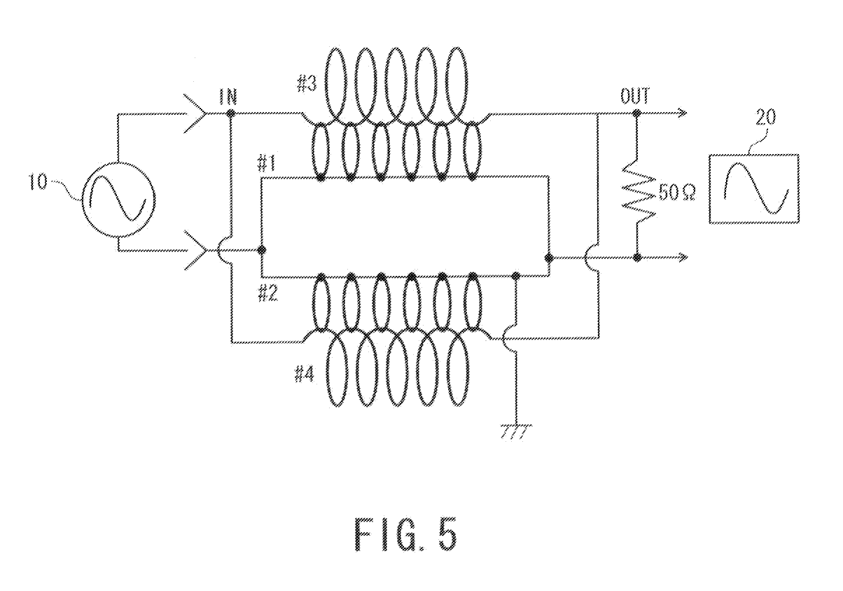

FIG. 5 is a schematic view of a measuring instrument used in the experiment.

In the measuring instrument, an oscillation source 10 is connected to the input side of a transmission medium including at least the transmission medium according to the invention (in the embodiment, a transmission path itself is composed of the transmission medium according to the invention), and a measuring instrument (in the embodiment, the oscilloscope) 20 is connected to the output side thereof to monitor the phase delay and the attenuated state of an output signal. An impedance matching (terminal end) resistor of 50Ω is connected to the output side oscilloscope 20.

The measuring instrument and the transmission path used for the experiment will be more specifically explained.

A first transmission line #11 (refer to FIG. 3) is arranged by connecting the input sides and the output sides of the first and second linear lines #1 and #2 of the transmission medium 1 shown in FIG. 1, respectively, a second transmission line #22 (refer to FIG. 3) is arranged by connecting the input sides and the output sides of the third and fourth curved lines #3 and #4, respectively, and a transmission signal is input from the oscillation source 10 by grounding the first transmission line #11 as the ground and using the second transmission line #22 as a signal line. An oscillation signal generated from the oscillation source 10 is a sine wave signal and a square wave signal having variable frequencies.

The transmission medium 1 of the present invention used here has a length of, for example, 29 m, inductance of 725 mH, and a resistance value of 3.3Ω. Further, it is to be noted that the transmission medium composed of the four lines can be also wound around a bobbin (a magnetic body core), which was confirmed by the experiment with the same effect as explained below even in this case.

Furthermore, results of an experiment and a measurement executed by using a conventional covered electric wire as the transmission medium 1 are shown at the same time.

A model AFG3102 made by Tektronix was used as the oscillator 10 of FIG. 5, a model DSC-9506 made by TEXIO was used as the oscilloscope, and a model RG-58A/U, Xm made by Kansai Tsushin Densen Co. Ltd. was used as a probe.

Further, as a conventional transmission path, an electric wire wound around a core was used, the wire having a length of 29 m (a wire diameter (of a core wire) of 0.35 mmφ), a wire outer diameter (including an insulating film) of 0.4 mmφ)), inductance of 725 mH, and a resistance of 3.3Ω. On the other hand, as the transmission medium of the present invention, a line having a length of 29 m and wound around a core was used likewise (both the linear lines #1 and #2 and the curved lines #3 and #4 had a line diameter (of a core line) of 0.35 mmφ) and a line outer diameter (including an insulating film) of 0.4 mmφ)). The curved lines #3 and #4 had inductance of 738 mH and a resistance of 4.0Ω, and the linear lines #1 and #2 had inductance of 741 mH and a resistance of 3.2Ω.

As measurement conditions, the signals generated by the oscillator 10 were a square wave signal having a frequency of 100 kHz, a phase of 0.0°, a voltage of 1.0 Vpp, and a sine wave signal having a frequency of 1 MHz, a phase 0.0°, and a voltage of 1.0 Vpp.

In general, a transmission path of a high frequency signal is equivalently composed of a distribution constant circuit such as floating inductance, a floating capacitance and, further, a resistance component. Accordingly, when a signal is transmitted, since a phase delay and amplitude attenuation (voltage drop) inevitably occur, a signal waveform is deteriorated as described above.

In contrast, it is confirmed also experimentally that when the transmission medium 1 is used, a phase delay and amplitude attenuation are reduced several orders of magnitude in comparison with a transmission path of a conventional transmission cable and the like.

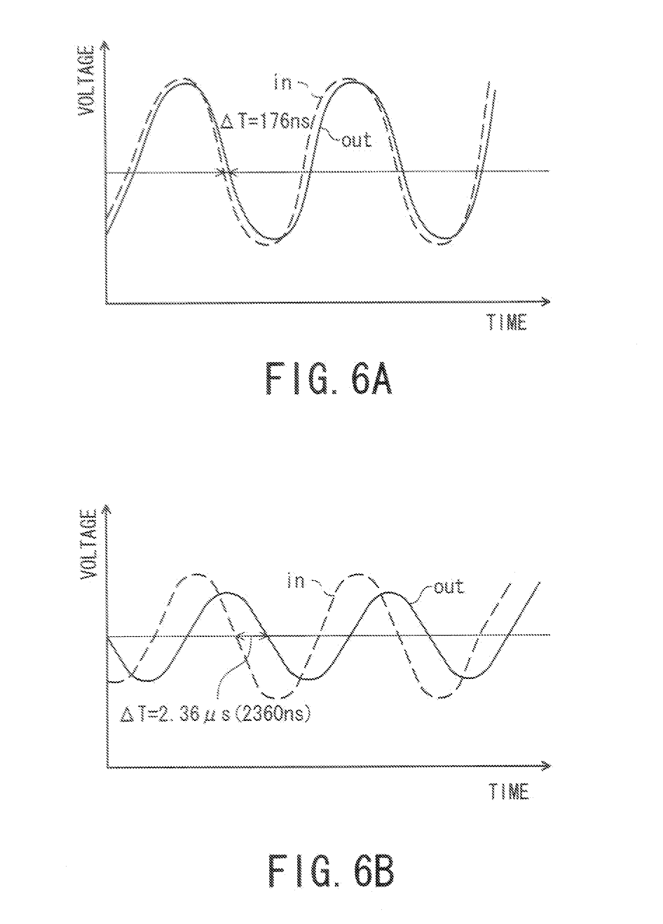

More specifically, FIGS. 6A and 6B show waveforms observed by the output side oscilloscope when a sine wave signal of 100 kHz was input from the oscillator 10 to the transmission medium according to the present invention and to a conventional transmission medium (electric wire).

The sine wave signal was input by using the transmission medium (transmission path) according to the present invention and the input waveform (shown by a dotted line “in”) and the output waveform (shown by a solid line “out”) of the signal were measured by the output side oscilloscope 20 using its horizontal axis as a time axis, and FIG. 6A shows the input waveform and the output waveform. In the experiment, a phase delay of 176 ns was observed.

In contrast, the sine wave signal was input by using the conventional transmission path and the input waveform (shown by a dotted line “in”) and the output waveform (shown by a solid line “out”) of the signal were measured by the output side oscilloscope 20 using the horizontal axis as a time axis, and FIG. 6B shows the input waveform (shown by a dotted line) and the output waveform (shown by a solid line). In the experiment, a phase delay of 2.36 μs (2,360 ns) was observed.

According to a result of the experiment, the phase delay of the conventional transmission path was 2,360 ns, whereas when the transmission medium according to the embodiment of the present invention was used, the phase delay of the transmission medium is 176 ns, and thus, could be suppressed to a value about one tenth or less of the conventional transmission path.

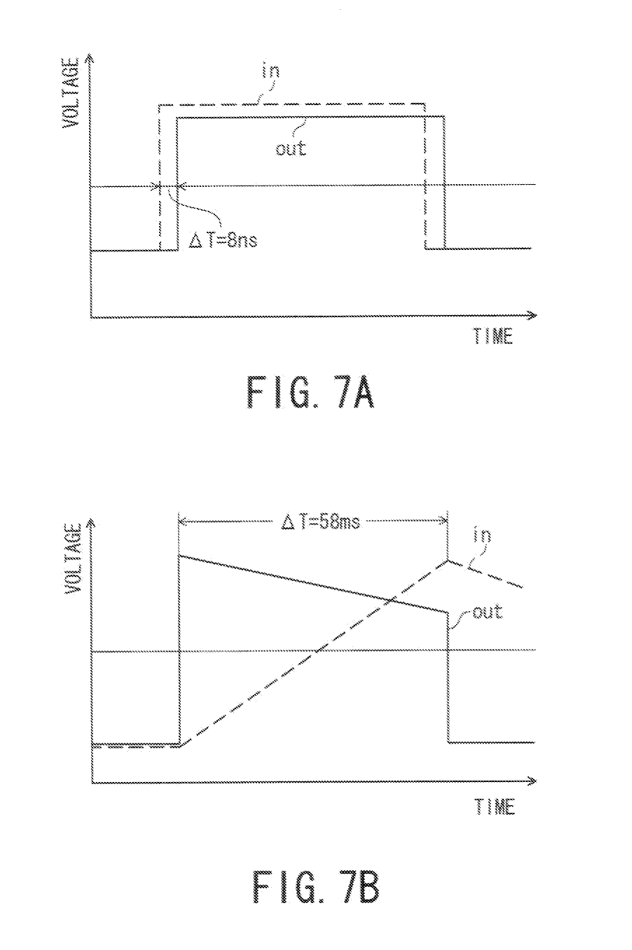

A square wave signal was input using the transmission medium (transmission path) according to the present invention and the input waveform (shown by a dotted line “in”) and the output waveform (shown by a solid line “out”) of the signal were measured by the output side oscilloscope 20 using its horizontal axis as a time axis, and FIG. 7A shows the input waveform and the output waveform. In the experiment, a phase delay of 8 ns was observed.

In contrast, the square wave signal was input by using the conventional transmission path and the input waveform (shown by a dotted line “in”) and the output waveform (shown by a solid line “out”) of the signal were measured by the output side oscilloscope 20 using its horizontal axis as a time axis, and FIG. 7B shows the input waveform and the output waveform. In the experiment, a phase delay of 58 ns was observed.

According to a result of the experiment, it could be confirmed that a conventional phase delay was 58 ns, whereas when the transmission medium according to the embodiment of the present invention was used, the phase delay of the transmission medium is 8 ns, and thus, could be suppressed to a value about one seventh or less of the conventional transmission path.

The results of the experiment is to be surprised and cannot be understood by an ordinary common sense when it is taken into consideration that the transmission medium is equivalently a distribution constant circuit particularly in a high frequency band. However, actually, the results are obtainable when the transmission medium of the present invention is used. It is considered that a main factor of the results resides in an electromagnetic interaction caused by the current flowing in the four lines #1 to #4 having the characteristic structures and arrangements described above.

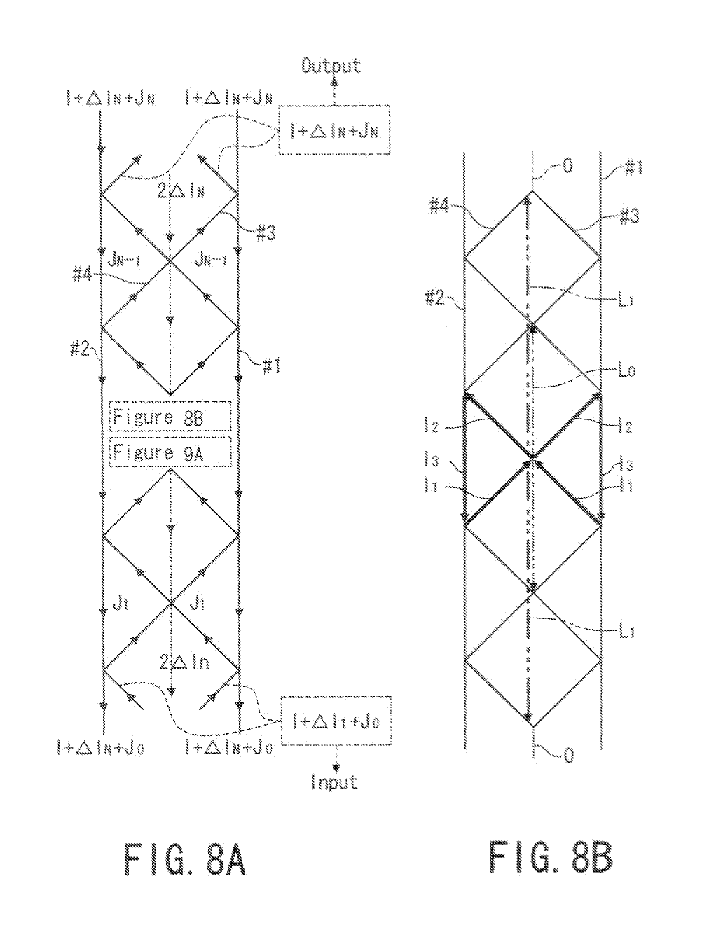

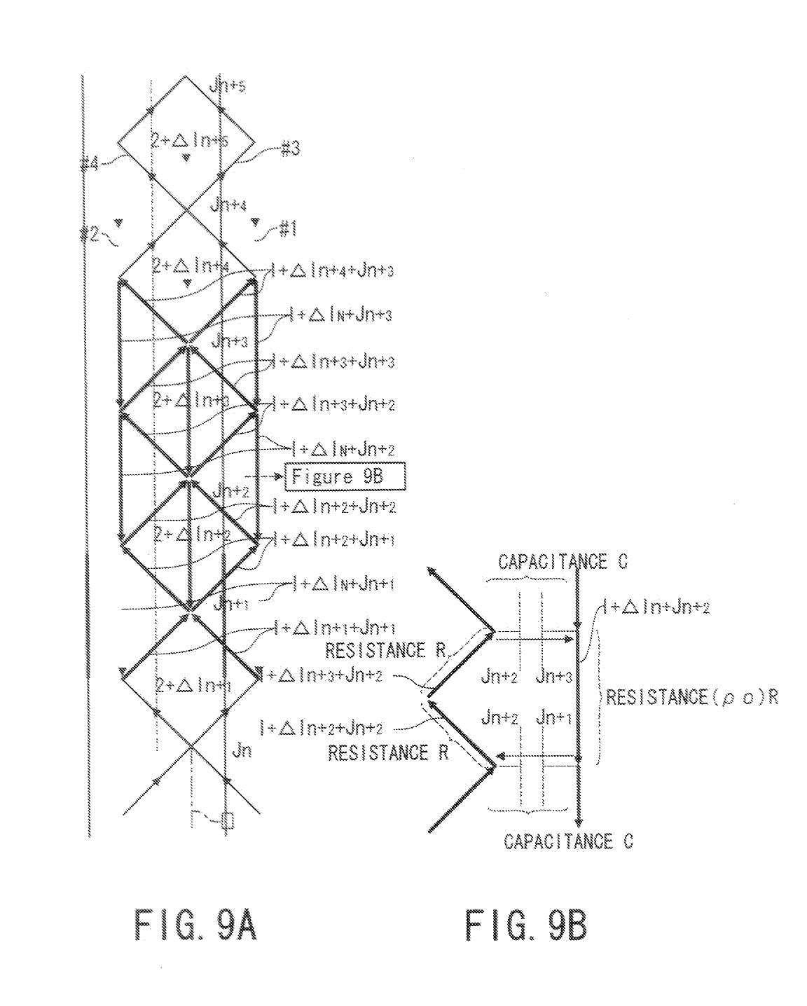

Mathematically theoretical consideration of the functions and effects of the present invention will be explained hereunder with reference to FIGS. 8A and 8B and FIGS. 9A and 9B, in which FIG. 8A is a schematic view showing a distribution of currents I₁, I₂, I₃, and the like on a two-dimensional plane of the transmission medium 1 shown in FIG. 1A, FIG. 8B is a schematic view showing a distribution of an electromagnetic field and the like of the transmission medium 1, FIG. 9A is a schematic view showing a mathematically theoretical model of a theoretical equation (0) of a mathematically theoretical model shown in FIG. 8B, and FIG. 9B is a partially enlarged view of FIG. 9A

First, it is to be assumed to set a mathematically theoretical model of the transmission medium 1 shown in FIGS. 8 and 9.

In theoretical model, it is considered that electromotive force, which is generated in a triangle eddy, i.e., between the end points of two central stitches (intersecting portions C1 to Cn) adjacent to an eddy current flowing in a triangle line surrounding spaces ma, mb in which a vertical variable magnetic field is generated in FIG. 1A, is induced by the vertical magnetic field of the triangle eddy and the vertical magnetic field generated by two adjacent triangle eddies (refer to FIG. 8B). Then, impedance is generated in a space along the center line of the stitches, and a current is caused to flow by the electromotive force (refer to FIG. 9). It will be clarified that the transmission medium 1 has transmission characteristics having a very small attenuation and delay by the above arrangement.

It is assumed that all the currents are alternating currents having a frequency, and symbols are defined as follows.

I: a current flowing from a stitch to a next stitch;

ΔI: ½ of a current flowing in a central space of an n-th stitch; and

Jₙ: an eddy current in a triangle between an n-th stitch and an (n+1)th stitch.

It must be noted at the time that the above setting satisfies Kirchhoff's current law.

Further, symbols are defined as follows.

### [Expression 1]

\tilde{R}(ω): Twice impedance of the space of the center of one stitch;

C: Inter-line capacitance of the isosceles sides and the bottom side of a triangle;

R: Resistance of one side of the isosceles sides of the triangle;

t=C·R: CR time constant of a circulation circuit of a triangle eddy;

ρ₀: Ration of the bottom side length of the triangle to the length of each of the isosceles sides;

ρ=2+ρ₀, p0, σ=2+σ₀

§1. Electromagnetic Field on Transmission Medium (refer to FIGS. 8A and 8B)

The setting of FIGS. 8A and 8B is assumed.

It would be found from electromagnetics that the electromagnetic field generated on the transmission medium is as follows.

A strong vertical variable magnetic field is generated in the respective triangle eddies (regions surrounded by thick black lines in FIG. 8B) of the transmission medium by Biot-Savart law. Further, the vertical variable magnetic field generates an electric field along the center line direction of the transmission medium by an electromagnetic induction law as shown by the following expression.

Thus, in theoretical model, consideration is made as follows.

The electromotive force induced between the end points of the two stitches (a two-dot-and-dash-arrow in FIG. 8B) is represented by the following expression.

### [Expression 2]

$$- {\tilde{L}}_{0} \cdot \frac{\partial }{\partial t} ( {I}_{1} + {I}_{2} + {σ}_{0} \cdot {I}_{3} )$$

Further, the electromotive force induced between the end points of two stitches (a three-dot-and-dash-arrow in FIG. 8B) in contact with an adjacent triangle eddy is represented by the following expression.

### [Expression 3]

$$- {\tilde{L}}_{1} \cdot \frac{\partial }{\partial t} ( {I}_{1} + {I}_{2} + {σ}_{0} \cdot {I}_{3} )$$

Here, it is assumed that the ratios of I₁, I₂, I₃ (thick black arrows in FIG. 8B) are near to 1, σ₀ is a constant determined from a shape of a transmission medium, and reactances \tilde{L}₀ and \tilde{L}₁ are values determined from the size and shape of the triangle.

### [Expression 4]

At the time, it is noted that the ratio \tilde{L}₀/\tilde{L}₁ of \tilde{L}₀ and \tilde{L}₁ is determined only by the shape of the transmission medium and does not depend on the size thereof, and then, the following expression is established.

1<\tilde{L}₀/\tilde{L}₁<2

(In the left inequation, since the three-dot-and-dash-line in FIG. 8B is farther from the triangle eddy than the three-dot-and-dash-line, it is represented as \tilde{L}₀<\tilde{L}₁.

Further, in the right inequation, since half the three-dot-and-dash-line in FIGS. 8 and 9 accords with half the two-dot-and-dash-line, \tilde{L}₀ is larger than \tilde{L}₁/2, and electromotive force, which is generated in half the three-dot-and-dash-line that does not accord with the two-dot-and-dash-line, is not 0, it is shown by \tilde{L}₀/2<\tilde{L}₁).

§2. Theoretical Equation of Transmission Medium (refer to FIG. 9)

It is assumed that setting is made as shown in FIG. 9A.

### [Expression 5]

In this theory, it is assumed that

$$\frac{\tilde{R} ( ω )}{ω \cdot {L}_{1}} {ω}_{0} << 1$$

is established only in a case of ω₀<<ω in which ω₀ is a frequency satisfying ω₀<<τ⁻¹.

Here, n=0, 1, . . . N−4.

Attention is paid to the electromotive force of the centers of two (n+2)th and (n+3)th stitches (FIG. 8B), the two-dot-and-dash-arrow)

$$\tilde{R} ( ω ) \cdot ( Δ {I}_{n + 2} ( t ) + Δ {I}_{n + 3} ( t ) ) = - \tilde{L} \cdot \frac{\partial }{\partial t} ( ( I ( t ) + Δ {I}_{n + 2} ( t ) + {J}_{n + 2} ( t ) ) + ( I ( t ) + Δ {I}_{n + 3} ( t ) + {J}_{n + 2} ( t ) ) + ( {σ}_{0} \cdot ( I + Δ {I}_{N} + {J}_{n + 2} ( t ) ) ) - {\tilde{L}}_{1} \cdot \frac{\partial }{\partial t} ( ( I ( t ) + Δ {I}_{n + 1} ( t ) + {J}_{n + 1} ( t ) ) + ( I + Δ {I}_{n + 2} ( t ) + {J}_{n + 1} ( t ) ) + ( {σ}_{0} ) ( I + Δ {I}_{N} ( t ) + {J}_{n + 1} ( t ) ) ) \qquad ( 0 )$$

(In FIG. 8B, a first term is a contribution due to the triangle eddy of the thick black arrow, a second term is a contribution due to the triangle eddy of the lower triangle eddy of the three-dot-and-dash-arrow, and a third term is a contribution due to the triangle eddy of the upper triangle eddy of the three-dot-and-dash-arrow.) [Expression 6]

Transformation of the expression 5 results in the following expression.

$$\tilde{R} ( ω ) \cdot ( Δ {I}_{n + 2} ( t ) + Δ {I}_{n + 3} ( t ) ) = - \tilde{L} \cdot \frac{\partial }{\partial T} ( σ \cdot I ( t ) + Δ {I}_{n + 2} ( t ) + Δ {I}_{n + 3} ( t ) + ( {σ}_{0} ) \cdot Δ {I}_{N} ( t ) + σ \cdot {J}_{n + 2} ( t ) ) - \tilde{L} \cdot \frac{\partial }{\partial T} ( 2 \cdot σ \cdot I ( t ) + Δ {I}_{n + 1} ( t ) + Δ {I}_{n + 2} ( t ) + 2 \cdot ( {σ}_{0} ) Δ {I}_{N} ( t ) + Δ {I}_{n + 3} ( t ) + Δ {I}_{n + 4} ( t ) + σ \cdot {J}_{n + 1} ( t ) + σ \cdot {J}_{n + 3} ( t ) )$$

### [Expression 7]

Furthermore, the following expression is obtained by further transforming the expression with respect to n=0, 1, . . . N−4.

$$( \tilde{R} ( ω ) + \tilde{L} \cdot \frac{\partial }{\partial t} ) \cdot ( Δ {I}_{n + 2} ( t ) + Δ {I}_{n + 3} ( t ) ) + {\tilde{L}}_{t} \cdot \frac{\partial }{\partial t} ( Δ {I}_{n + 1} ( t ) + Δ {I}_{n + 2} ( t ) + Δ {I}_{n + 3} ( t ) + Δ {I}_{n + 4} ( t ) ) = - ( \tilde{L} \cdot \frac{\partial }{\partial t} ) \cdot ( σ \cdot I ( t ) + ( {σ}_{0} ) \cdot Δ {I}_{N} ( t ) + σ \cdot {J}_{n + 2} ( t ) ) - ( \tilde{L} \cdot \frac{\partial }{\partial t} ) \cdot ( σ \cdot I ( t ) + 2 \cdot ( {σ}_{0} ) \cdot Δ {I}_{N} ( t ) + σ \cdot {J}_{n + 1} ( t ) + σ \cdot Δ {J}_{n + 3} ( t ) ) ) \qquad ( 1 )$$

[Expression 8]

Next, the following expression is obtained by applying Kirchhoff's voltage law to the circulation circuit of the thick line triangle eddy of FIG. 9A (refer also to FIG. 9B) with respect to n=−1, 0, . . . , N−3.

$$\frac{1}{C} \int ( ( {J}_{n + 2} ( t ) + {J}_{n + 3} ( t ) ) + ( {J}_{n + 2} ( t ) - {J}_{n + 1} ( t ) ) ) d t + ( R \cdot ( ( I ( t ) + Δ {I}_{n + 2} ( t ) + {J}_{n + 2} ( t ) ) + R \cdot ( I ( t ) + Δ {I}_{n + 3} ( t ) + {J}_{n + 2} ( t ) ) + ( {ρ}_{0} \cdot R ) \cdot ( I ( t ) + Δ {I}_{N} ( t ) + {J}_{n + 2} ( t ) ) ) = 0 \\ Thus , \\ \frac{1}{C} \int ( ( {J}_{n + 2} ( t ) - {J}_{n + 3} ( t ) ) + ( {J}_{n + 2} ( t ) - {J}_{n + 1} ( t ) ) ) + R \cdot \frac{\partial }{\partial t} ( ( I ( t ) + Δ {I}_{n + 2} ( t ) + {J}_{n + 2} ( t ) ) + ( I ( t ) + Δ {I}_{n + 3} ( t ) + {J}_{n + 2} ( t ) ) + {ρ}_{0} \cdot ( I ( t ) + Δ {I}_{N} ( t ) + {J}_{n + 2} ( t ) ) ) = 0$$

Thus, when attention is paid to τ

$$( {J}_{n + 2} ( t ) - {J}_{n + 3} ( t ) ) + ( {J}_{n + 2} ( t ) - {J}_{n + 1} ( t ) ) + τ \cdot \frac{\partial }{\partial t} ( ( I ( t ) + Δ {I}_{n + 2} ( t ) + {J}_{n + 2} ( t ) ) + ( I ( t ) + Δ {I}_{n + 3} ( t ) + {J}_{n + 2} ( t ) ) + {ρ}_{0} \cdot ( I ( t ) + Δ {I}_{N} ( t ) + {J}_{n + 2} ( t ) ) ) = 0$$

### [Expression 9]

Accordingly,

$$- 2 \cdot {J}_{n + 2} ( t ) + {J}_{n + 1} ( t ) + {J}_{n + 3} ( t ) = τ \cdot \frac{\partial }{\partial t} ( ρ \cdot I ( t ) + Δ {I}_{n + 2} ( t ) + Δ {I}_{n + 3} ( t ) + {ρ}_{0} \cdot Δ {I}_{N} ( t ) + ρ \cdot {J}_{n + 2} ( t ) ) \qquad ( 2 )$$

The expression is deformed, all the currents are made to alternating currents, with respect to n=0, 1, . . . N−4.

$$\begin{matrix}( \tilde{R} ( ω ) + j \cdot ω \cdot {\tilde{L}}_{0} ) \cdot ( Δ {I}_{n + 2} ( t ) + Δ {I}_{n + 3} ( t ) ) + j \cdot ω \cdot {\tilde{L}}_{1} ( Δ {I}_{n + 1} ( t ) + Δ {I}_{n + 2} ( t ) + Δ {I}_{n + 3} ( t ) + Δ {I}_{n + 4} ( t ) ) = - ( j \cdot ω \cdot {\tilde{L}}_{0} ) \cdot ( σ \cdot I ( t ) + ( {σ}_{0} ) \cdot Δ {I}_{N} ( t ) + σ \cdot {J}_{n + 2} ( t ) ) - ( j \cdot ω \cdot {\tilde{L}}_{1} ) \cdot ( σ \cdot I ( t ) + 2 \cdot ( {σ}_{0} ) \cdot Δ {I}_{N} ( t ) + σ \cdot {J}_{n + 1} ( t ) + σ \cdot {J}_{n + 3} ( t ) ) & ( 3 ) \\ - 2 \cdot {J}_{n + 2} ( t ) + ( {J}_{n + 1} ( t ) + {J}_{n + 3} ( t ) ) = j \cdot ω \cdot τ ( ρ \cdot I ( t ) + ρ \cdot {J}_{n + 2} ( t ) + Δ {I}_{n + 2} ( t ) + Δ {I}_{n + 3} ( t ) + {ρ}_{0} \cdot Δ {I}_{N} ( t ) ) & ( 4 )\end{matrix}$$

Further, the following expression is obtained with respect to n=−1, 0, . . . , N−3, and (3) and (4) (n=0, 1, . . . N−4) are called theoretical equations of the transmission medium.

### [Expression 10]

In the expression,

$${X}_{n} = \frac{Δ {I}_{n}}{I} for n = 1 , 2 , … , N , \\ and$$

$${Y}_{n} = \frac{{J}_{n}}{I} for n = 0 , 1 , 2 , … , N ,$$

when a difference between values whose number is different by 1 from that in the above theoretical equation, the following equation can be obtained with respect to n=0, 1, . . . N−5.

### [Expression 11]

$$( \tilde{R} ( ω ) + j \cdot ω \cdot {\tilde{L}}_{0} ) ( {X}_{n + 4} + {X}_{n + 2} ) + j \cdot ω \cdot {\tilde{L}}_{1} ( {X}_{n + 5} + {X}_{n + 1} ) = - jω {\tilde{L}}_{0} σ ( {Y}_{n + 3} - {Y}_{n + 2} ) - jω {\tilde{L}}_{1} σ ( {Y}_{n + 4} - {Y}_{n + 3} + {Y}_{n + 2} - {Y}_{n + 1} ) \qquad ( 5 )$$

### [Expression 12]

Further, the following expression is established with respect to n=−1, 0, 1, . . . , N−4.

$$2 ( {Y}_{n + 3} - {Y}_{n + 2} ) - ( {Y}_{n + 2} - {Y}_{n + 1} + {Y}_{n + 4} - {Y}_{n + 3} ) = jωτ ( {X}_{n + 4} - {X}_{n + 2} + ρ ( {Y}_{n + 3} - {Y}_{n + 2} ) ) \qquad ( 6 )$$

(5) is solved for Xn+5 and with respect to (n=0, 1, N−5)

$${X}_{n + 5} = {X}_{n + 1} + ( - \frac{{\tilde{L}}_{0}}{{\tilde{L}}_{1}} + j \cdot \frac{\tilde{R} ( ω )}{ω \cdot {\tilde{L}}_{1}} ) ( {X}_{n + 4} - {X}_{n + 2} ) - σ \cdot \frac{{\tilde{L}}_{0}}{{\tilde{L}}_{1}} ( {Y}_{n + 3} - {Y}_{n + 2} ) - σ \cdot ( {Y}_{n + 4} - {Y}_{n + 3} + {Y}_{n + 2} - {Y}_{n + 1} ) \qquad ( 7 )$$

When (6) is set to n+1 and solved for Yn+5, the following expression is obtained with respect to n=−2, −1, 0, 1, . . . N−5

Yₙ₊₅=(3−j·ω·τ·ρ)(Yₙ₊₄−Yₙ₊₃)+Yₙ₊₂−j·ω·τ(Xₙ₊₅−Xₙ₊₃) (8)

It is assumed that the above (7), (8) are called theoretical difference equations.

### [Expression 13]

Further, when n=0, 1, 2, . . . ,

yₙ=Yₙ−Yₙ₋₁,xₙ=Xₙ−Xₙ₋₂+(n−2)[n/2]σyₙ₋₁

The theoretical difference equation of the transmission medium can be written as follows. However, it is noted that the equations can be written as follows with respect to n=0, 2, 4, . . . .

$$\begin{matrix} {x}_{n + 5} = - {x}_{n + 3} + ( - \frac{{\tilde{L}}_{0}}{{\tilde{L}}_{1}} + j \cdot \frac{\tilde{R} ( ω )}{ω \cdot \tilde{L}} ) {x}_{n + 4} - σ \frac{{\tilde{L}}_{0}}{{\tilde{L}}_{1}} {y}_{n + 3} & ( 9 ) \\ {x}_{n + 6} = - {x}_{n + 4} + ( - \frac{{\tilde{L}}_{0}}{{\tilde{L}}_{1}} + j \cdot \frac{\tilde{R} ( ω )}{ω \cdot {\tilde{L}}_{1}} ) \cdot {x}_{n + 5} - j \cdot σ \cdot \frac{\tilde{R} ( ω )}{{\tilde{L}}_{1}} \cdot {y}_{n + 4} - σ ( {y}_{n + 3} + {y}_{n + 5} ) & ( 10 ) \\ {y}_{n + 5} = ( 2 - j \cdot ω \cdot τ \cdot ( ρ - σ ) ) \cdot {y}_{n + 4} - {y}_{n + 3} - j \cdot ω \cdot τ \cdot {x}_{n + 5} & ( 11 ) \\ {y}_{n + 6} = - j \cdot τ \cdot ω \cdot {x}_{n + 5} - {y}_{n + 4} + ( 2 - ρ \cdot jω \cdot τ ) \cdot {y}_{n + 5} & ( 12 )\end{matrix}$$

### [Expression 14]

Here, when:

$$f ( {z}_{1} , {z}_{2} , {z}_{3} , {z}_{4} , {w}_{1} , {w}_{2} , {w}_{3} , {w}_{4} , a , b , c , s , t ) = {z}_{1} + ( - a + j \cdot s ) ( {z}_{4} - {z}_{2} ) - b \cdot a \cdot ( {w}_{3} - {w}_{2} ) - b \cdot ( {w}_{4} - {w}_{3} + {w}_{2} - {w}_{1} ) \qquad ( 13 )$$

(7) is expressed as

$${X}_{5} = f ( \begin{matrix}{X}_{1} , {X}_{2} , {X}_{3} , {X}_{4} , {Y}_{1} , {Y}_{2} , {Y}_{3} , {Y}_{4} , \\ \frac{{L}_{0}}{{L}_{1}} , σ , ρ , \frac{\tilde{R} ( ω )}{ω \cdot {L}_{1}} , τ \cdot ω\end{matrix} ) \qquad ( 14 )$$

Further, when (15) is shown as

g(z₁,z₂,z₃,z₄,w₁,w₂,w₃,w₄,a,b,c,s,t)=(3−j·t·c)(w₄−w₃)+w₂=j·t·(f(z₁,z₂,z₃,z₄,w₁,w₂,w₃,w₄,a,b,c,s,t)−z₃) [Expression 15]

(8) is represented as:

$${Y}_{5} = g ( \begin{matrix}{X}_{1} , {X}_{2} , {X}_{3} , {X}_{4} , {Y}_{1} , {Y}_{2} , {Y}_{3} , {Y}_{4} , \\ \frac{{L}_{0}}{{L}_{1}} , σ , ρ , \frac{\tilde{R} ( ω )}{ω \cdot {L}_{1}} , τ \cdot ω\end{matrix} ) \qquad ( 16 )$$

### [Expression 16]

By using the above expression, when V=(X₁,X₂,X₃,X₄,Y₁,Y₂,Y₃,Y₄)^{t}, W(X₅,X₆,X₇,X₈,Y₅,Y₆,Y₇,Y₈)^{t}, the following equation can be written using an eighth matrix.

Thus, an asymptotic expression can be solved as follows.

$${X}_{n} = {( {A ( \frac{{L}_{0}}{{L}_{1}} , σ , ρ , \frac{\tilde{R} ( ω )}{ω \cdot {L}_{1}} , τ \cdot ω )}^{[ ( n - 1 / 4 ) ]} \cdot V )}_{n - 1 - 4 [ ( n - 1 / 4 ) ]} , \\ {Y}_{n} = {( {A ( \frac{{L}_{0}}{{L}_{1}} , σ , ρ , \frac{\tilde{R} ( ω )}{ω \cdot {L}_{1}} , τ \cdot ω )}^{[ ( n - 1 / 4 ) ]} \cdot V )}_{n + 3 - 4 [ ( n - 1 / 4 ) ]} \qquad ( 17 )$$

Further, it must be noted that this can be calculated using a fourth matrix when (9), (10), (11), (12) are used.

§3. Characteristic Matrix of Theoretical Equation

### [Expression 17]

(1) a matrix

$$A ( \frac{{L}_{0}}{{L}_{1}} , σ , ρ , \frac{\tilde{R} ( ω )}{ω \cdot {L}_{1}} , τ \cdot ω )$$

has an inherent value which does not depends on a frequency and its inherent vector of (1,0,1,0,0,0,0,0),(0,1,0,1,0,0,0,0),(,0,0,0,0,1,1,1,1).

### [Expression 18]

It must be noted that a first inherent vector gives a solution, which takes the same value in an odd number and 0 in an even number, by (17) and that a second inherent vector gives a solution, which takes the same value in an even number and 0 in an odd number, by (18). Further they have an inherent value 0 and its inherent vector of (σ,0,0,0,1,0,0,0)^{t}.

Further,

$$A ( \frac{{L}_{0}}{{L}_{1}} , σ , ρ , 0 , 0 )$$

has inherent values 1, 1 and α and α⁻¹. However, when

$$0 < \frac{{L}_{0}}{{L}_{1}} < 2 , \vert α \vert = 1 , α \neq 1 ,$$

and when

$$\frac{{L}_{0}}{{L}_{1}} \geq 2 ,$$

a is an actual number.

### [Expression 19]

Verification: an inherent value; which does not depend on a frequency, can be directly confirmed easily. The following expression is established by a specific calculation.

$$A ( a , b , c , 0 , 0 ) = ( \begin{matrix}1 & a & 0 & - a & * & * & * & * \\ - a & 1 - {a}^{2} & a & {a}^{2} & * & * & * & * \\ {a}^{2} & {a}^{3} - a & 1 - {a}^{2} & - {a}^{3} + a & * & * & * & * \\ - {a}^{3} + a & - {a}^{4} + 2 {a}^{2} & {a}^{3} - a & {a}^{4} - 2 {a}^{2} + 1 & * & * & * & * \\ 0 & 0 & 0 & 0 & 0 & 1 & - 3 & 3 \\ 0 & 0 & 0 & 0 & 0 & 3 & - 8 & 6 \\ 0 & 0 & 0 & 0 & 0 & 6 & - 15 & 10 \\ 0 & 0 & 0 & 0 & 0 & 10 & - 24 & 15\end{matrix} )$$

### [Expression 20]

The inherent polynomial of A (a,b,c,0,0) is as shown below.

$$\begin{matrix}\vert t \cdot {E}_{g} - A ( a , b , c , 0 , 0 ) \vert = {t ( t - 1 )}^{5} ( {t}^{2} - ( {a}^{4} + 4 {a}^{2} + 2 ) t + 1 ) \\ = - {t ( t - 1 )}^{5} ( t - {α}_{0} ( a ) ) ( t - {α}_{1} ( a ) )\end{matrix}$$

Further, this is based on the following expressions.

α₀(a)=(1/2)(a⁴−4a²+2)+(1/2)\sqrt{−1}\sqrt{4−(a⁴−4a²+2)²,}

α₁(a)=(1/2)(a⁴−4a²+2)−(1/2)\sqrt{−1}\sqrt{4−(a⁴−4a²+2)²}

### [Expression 21]

Accordingly, there are inherent values 1, 1, α₀(a), α₁(a) other than the inherent values 1,1,1,0. At the time, attention must be paid that α₀(a)·α₁(a)=1 is established.

When attention is paid to 4−(a⁴−4a²+2)²=a²(a²−2)²(4−a²) at the time a≧2, it can be found that α₀(a), α₁(a) is an actual number.

When attention is paid, at the time of a<2, to ((a⁴−4a²+2)/2)²+({square root over (4−((a⁴−4a²+2)²)}/2)²=1, |α₀(a)|=βα₁(a)|=1 is established.

Accordingly, in the case of α⁻¹=α₁(a), αa=α₀(a) is established and the meaning of the title is established.

### [Expression 22]

Accordingly, when

$$\frac{\tilde{R} ( ω )}{ω \cdot {L}_{1}} << 1 , τ \cdot ω << 1 ,$$

that is, when the frequency is shown by (18) at the time ω₀<<ω<<τ⁻¹, it is considered that the following expression is established.

$$A ( \frac{{L}_{0}}{{L}_{1}} , σ , ρ , \frac{\tilde{R} ( ω )}{ω \cdot {L}_{1}} , τ \cdot ω ) \approx A ( \frac{{L}_{0}}{{L}_{1}} , σ , ρ , 0 , 0 )$$

Accordingly, there are two inherent values near to 1 and two inherent values near to α, α⁻¹ in addition to the inherent values 1, 1, 1, 0 which does not depends on the frequency.

### [Expression 23]

(2) Here, 1<\tilde{L}₀/\tilde{L}₁<2 is assumed.

Further, there is a constant C which does not depend on a frequency ω to a sufficiently large “m”, the following expression is established to all the |V|<<1 in ω₀<<τ⁻¹.

$$\vert {A ( \frac{{L}_{0}}{{L}_{1}} , σ , ρ , \frac{\tilde{R} ( ω )}{ω \cdot {L}_{1}} , τ \cdot ω )}^{m} \cdot V \vert ≦ C \cdot \vert V \vert$$

### [Expression 24]

Verification: Under a condition I<\tilde{L}₀/\tilde{L}₁<2, when ω₀<<ω<<τ⁻¹,

$${A ( \frac{{L}_{0}}{{L}_{1}} , σ , ρ , \frac{\tilde{R} ( ω )}{ω \cdot {L}_{1}} , τ \cdot ω )}^{m}$$

is a constant C which does not depend on a frequency ω by a pertubation theory of a matrix because eight inherent values are only seven inherent values and a 0 inherent value, and the following expression is established.

$$\vert {A ( \frac{{L}_{0}}{{L}_{1}} , σ , ρ , \frac{\tilde{R} ( ω )}{ω \cdot {L}_{1}} , τ \cdot ω )}^{m} \cdot V \vert ≦ C \cdot \vert V \vert$$

§4. Input/Output Characteristics

To determine the input/output characteristics of a transmission medium having N pieces of stitches, theoretical equation systems (3), (4) of the transmission medium must be solved.

Theoretical equation systems have the same values as those of theoretical difference equation systems (7), (8) and (3) of n=N−4 and (4) of n=N−3.

### [Expression 25]

Here, a terminal end boundary condition V=(X_{N-3}, X_{N-2}, X_{N-}1, X_{N}, Y_{N-4}, Y_{N-3}, Y_{N-2}, Y_{N-1}, and v₀=Y₀ are given so that (3) of n=N−4, (4) of n=N−3, and (8) of n=N−5, N−6 are satisfied. Then, Xₙ, Yₙ having small n can be inductively determined.

Accordingly, here, input/output characteristics are determined by solving a terminal end boundary value problem.
(It is difficult to treat an input end boundary value problem in comparison with the terminal end boundary value problem).

### [Expression 26]

Hereinafter, the stitches are renumbered by observing the transmission medium in an opposite direction, and the input/output ratio of the transmission medium having the number N of the stitches, as follows, is examined under the boundary value condition.

$${y}_{N} = \frac{I + Δ {I}_{1} + {J}_{0}}{I + Δ {I}_{N} + {J}_{N}} = \frac{1 + {X}_{1} + {Y}_{0}}{1 + {X}_{N} + {Y}_{N}}$$

### [Expression 27]

First, a terminal end boundary value condition V=(X₁,X₂,X₃,X₄, Y₁, Y₂, Y₃, Y₄)^{t}, v₀=Y₀ is given to satisfy (8) of n=−2, −1, and next (19) and (20) (derived from (3) of n=N−4 and (4) of n=N−3).

### [Expression 28]

$$\begin{matrix}{X}_{4} = - ( {X}_{1} + {X}_{2} + {X}_{3} ) - ( \frac{{\tilde{L}}_{0}}{{\tilde{L}}_{1}} - j \cdot \frac{\tilde{R} ( ω )}{ω \cdot {\tilde{L}}_{1}} ) ( {X}_{2} + {X}_{3} ) - \frac{{\tilde{L}}_{0}}{{\tilde{L}}_{1}} \cdot ( σ + ( σ - 2 ) \cdot {X}_{1} + σ \cdot {Y}_{2} ) - ( σ + 2 ( σ - 2 ) \cdot {X}_{1} + σ \cdot ( {Y}_{1} + {Y}_{3} ) ) & ( 19 ) \\ {Y}_{2} = - {Y}_{0} + 2 \cdot {Y}_{1} + j \cdot ω \cdot τ ( ρ + ρ \cdot {Y}_{1} + {X}_{1} + {X}_{2} + ρ \cdot {X}_{1} ) & ( 20 )\end{matrix}$$

### [Expression 29]

At the time, attention must be paid to I<\tilde{L}₀/\tilde{L}₁<2 as observed in §1. It is assumed here that the frequency ω satisfies (18).

At the time, a terminal end boundary condition, which satisfies |V(ω)+V(ω)|<<1, |v₀(ω)−v′₀(ω)|<<1 in a certain V′(ω)∈W1.

### [Expression 30]

First, from the assumption, the following expression is obtained.

$${A ( \frac{{L}_{0}}{{L}_{1}} , σ , ρ , \frac{\tilde{R} ( ω )}{ω \cdot {L}_{0}} , τ \cdot ω )}^{[ ( N - 1 ) / 4 ]} \cdot {V}^{′} ( ω ) = {V}^{′} ( ω )$$

When m=[(N−1)/4], the following expression is obtained from (2) of §3.

$$\vert {A ( \frac{{L}_{0}}{{L}_{1}} , σ , ρ , \frac{\tilde{R} ( ω )}{ω \cdot {L}_{0}} , τ \cdot ω )}^{[ ( N - 1 ) / 4 ]} \cdot ( {V}^{′} ( ω ) - V ( ω ) ) \vert ≧ C \cdot \vert {V}^{′} ( ω ) - V ( ω ) \vert << 1$$

### [Expression 31]

Accordingly, the following expression is obtained.

$$\vert {A ( \frac{{L}_{0}}{{L}_{1}} , σ , ρ , \frac{\tilde{R} ( ω )}{ω \cdot {L}_{0}} , τ \cdot ω )}^{[ ( N - 1 ) / 4 ]} \cdot ( {V}^{′} ( ω ) - V ( ω ) ) \vert << 1$$

As a result, X₁≈X_{N} and Y₀≈Y_{N} can be obtained. Thus, y_{N}≈1 is established and it can be found that attenuation and a delay do not almost occur.

### CONCLUSION

When a frequency is as shown in (18), i.e., when ω₀<<w <<τ⁻¹, that is, when a terminal end boundary condition is sufficiently near to the terminal end boundary condition of a non-attenuation/non-delay-solution, the attenuation and a delay are very small. Further, the value taken by the solution at that time is sufficiently near to the value taken by the non-attenuation/non-delay solution. Accordingly, since the non-attenuation/non-delay solution has stability in this meaning, an actual physical phenomenon may appear. In contrast, when a frequency is not as shown in (18), the non-attenuation/non-delay solution only slightly moves the terminal end boundary condition and is made to a solution having a large amount of attenuation. In this meaning, the non-attenuation/non-delay solution does not provide the stability and does not physically exist, and thus, the solution is limited only to a solution having a large amount of attenuation and a delay.

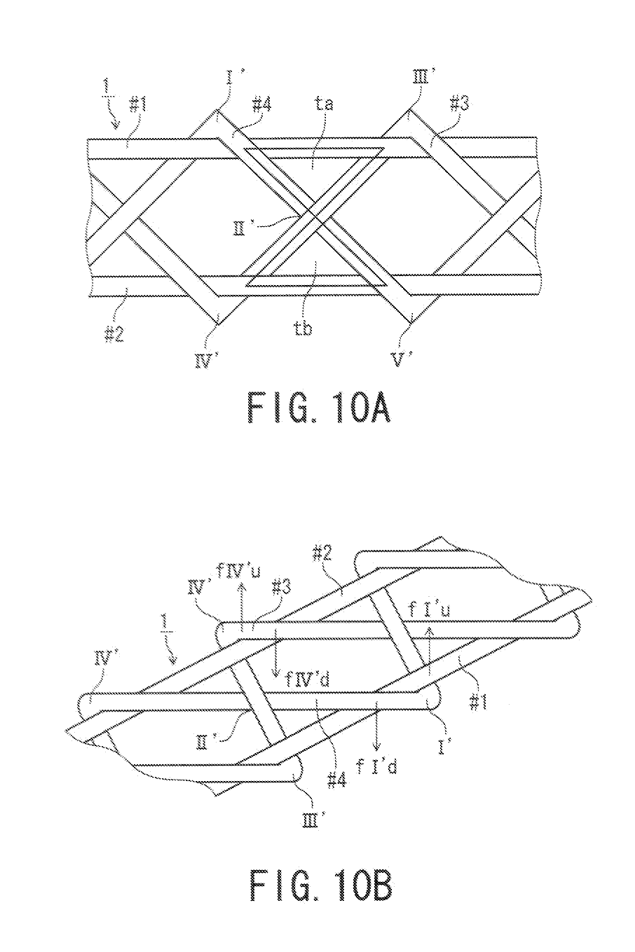

FIG. 10A is a partially enlarged view of the transmission medium 1 according to the present invention shown in FIG. 1A, and FIG. 10B is a perspective view of FIG. 1B.

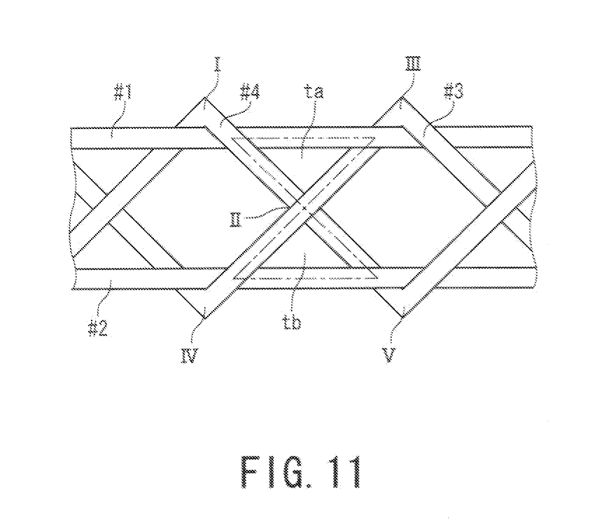

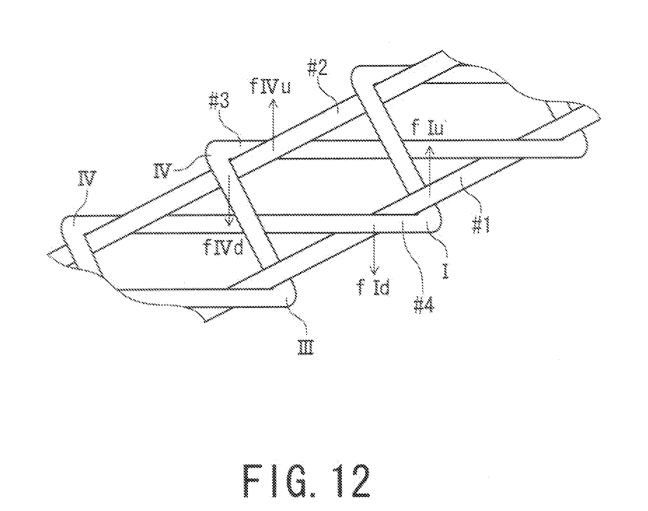

As shown in the part (A) of FIG. 10, the transmission medium 1 has a feature in that the method of knitting the third and fourth lines #3, #4 which are entangled with the first and second lines #1, #2 is more symmetrical than the method of knitting the transmission medium according to the previous application shown in FIGS. 11 and 12.

More specifically, as shown in FIG. 10A, the transmission medium 1 has an upper triangle portion “ta” surrounded by points I′, II′, III′ in the figure and a lower triangle portion tb surrounded by points IV′, II′, V in the figure. The upper triangle portion “ta” is surrounded by a first line #1 and third and fourth lines #3 and #4. As described above, these triangle portions “ta” and “tb” are triangle eddies in which an eddy current flows and in which a vertical variable magnetic field is generated, and a strong electromagnetic wave is generated from the apexes (intersecting portions C1 to Cn) of the triangle portions “ta” and “tb” adjacent to each other on the upper and lower sides.

The first, third, and fourth lines #1, #3 and #4 overlap each other in the upper triangle portion “ta” in such a manner that the fourth line #4 extends round the first line #1 from the lower side thereof to the upper side thereof at the point I′, is bent at approximately right angles on the first line #1, and extends approximately linearly toward the point V under a second line #2 after passing under the third line #3 at the point II′. When this state is shown by, for example, #4: I′ (on #1)→II′ (under #3), the third line #3 may be shown by #3: II′ (on #4)→III′ (under #1). Further, the first line #1 may be shown by #1: II′ (under #4)→II′ (under #3).

Then, in the overlapping state of the second, third and fourth lines #2, #3 and #4 in the lower triangle portion “tb” in the figure, the third line #3 is shown by #3: IV′ (under #1)→II′ (on #3). The fourth line #4 is shown by #4: II′ (under #3)→V′ (on #2). The second line #2 is shown by #2: IV′ (on #3)→V′ (under #3).

Accordingly, the respective lines #1 to #4 alternately intersect also in the upper and lower triangle portions “ta” and “tb”, respectively, so as to be overlapped symmetrically. Further, the transmission medium has a symmetrical property in its entirety even if it is observed from any direction of upper, lower, right, left, front and back directions.

When the respective lines #1 to #4 overlap symmetrically in the triangle portions “ta” and “tb” as described above, they have a symmetrical up/down relation at the intersecting points (I′ to V′) of the respective lines #1 to #4 of the triangle portions “ta” and “tb”. Therefore, the first and second lines #1 and #2 are uniformly tightened so as to be sandwiched by the third and fourth lines #3 and #4 at the respective points I′, III′, IV′ and V′.

More specifically, when it is supposed that the upward and downward forces, which are received by the first line #1 from the fourth line #4 at the point I′, are represented by f_{I′u}, f_{I′u}, respectively, and the upward and downward forces, which are received by the second line #2 from the third line #3 at the point IV′, are represented by f_{IV′u}, f_{IV′d}, respectively, as shown in FIG. 10B, an equation f_{I′u}=f_{I′d}=f_{IV′u}=f_{IV′d} is established in the symmetrical knitting method. Accordingly, even if the external force is applied, since the shapes at the respective intersecting points are kept, the overall shape of the transmission medium is hard to be collapsed.

Thus, according to the transmission medium 1 of the present embodiment, even if the external force is applied, the amount of deformation of the triangle portions “ta” and “tb”, in which the vertical variable magnetic field is generated, can be suppressed, and accordingly, the suppression of the transmission delay and the amplitude (voltage) attenuation of a signal and electric power, which is an effect of the transmission medium 1, can be realized.

It is further to be noted that the transmission medium according to the present invention may be also applicable to an electric power cable for transmitting and distributing electric power.

### INDUSTRIAL APPLICABILITY

According to the present invention, the transmission delay and the amplitude (voltage) attenuation of a signal and electric power can be reduced.

1. A transmission medium comprising:
first and second conducting wires, which are separated from each other and disposed substantially in parallel with each other;
a third conducting wire, which is alternately entangled and wound around the first and second conducting wires from one direction thereof so as to form a plurality of entangling portions in a longitudinal direction of the first and second conducting wires, respectively; and
a fourth conducting wire, which forms a plurality of entangling portions where the fourth conducting wire is alternately entangled and wound around the first and second conducting wires from one direction thereof and a plurality of intersecting portions where the fourth conducting wire intersects the third conducting wire internally of the first and second conducting wires in the longitudinal direction of the first and second conducting wires, respectively,
wherein, the respective entangling portions of the third and fourth conductor wires are alternately arranged along the longitudinal direction of the first and second conductor wires, respectively, the winding direction of one of the first and second conductor wires is the same as the winding directions of the respective entangling portions of the third and fourth conductor wires, the winding directions of the respective entangling portions of the first and second conductor wires are alternately opposite directions each other, and the overlapping directions of the third and fourth conductor wires in the respective intersecting portions are alternately opposite directions each other in the longitudinal direction of the first and second conductor wires.

2. The transmission medium according to claim 1, wherein the first to fourth conductor wires are disposed in a range in which an electromagnetic interaction caused by current flowing in the conductor wires acts.

3. The transmission medium according to claim 1 or 2, wherein the third and fourth conductor wires have modes of shapes formed in a sine wave shape by being entangled with the first and second conductor wires.

4. The transmission medium according to claim 1 or 2, wherein the third and fourth conductor wires have modes of shapes formed in a chevron shape by being entangled with the first and second conductor wires.

5. The transmission medium according to any one of claims 1 to 4, wherein the first to fourth conductor wires are commonly connected on input end sides and output end sides thereof.

6. The transmission medium according to any one of claims 1 to 4, wherein the first and second conductor wires are commonly connected on input end sides and output end sides thereof, and the third and fourth conductor wires are commonly connected on input end sides and output end sides thereof.

7. The transmission medium according to claim 6, wherein the commonly connected portions of the first and second conductor wires are grounded, and electric power such as in form of a signal is input from the commonly connected input side of the third and fourth conductor wires.

8. The transmission medium according to any one of claims 1 to 4, wherein the first and second conductor wires are commonly connected on the input end sides and the output end sides thereof, and the third and fourth conductor wires are used as independent conductor wires.

9. The transmission medium according to claim 8, wherein the first and second conductor wires are commonly connected and grounded, and the third and fourth conductor wires are used as independent signal conductor wires.
